(19) United States
(12) Patent Application Publication
(10) Pub. No.: US 2016/0094367 A1
(43) Pub. Date: Mar. 31, 2016

(54) MIGRATING MULTICAST FLOW

(71) Applicant: HANGZHOU H3C TECHNOLOGIES CO.,LTD., Hangzhou, Zhejiang (CN)

(72) Inventors: Weiliang QU, Beijing (CN); Wan ZHOU, Beijing (CN)

(73) Assignee: HANGZHOU H3C TECHNOLOGIES CO.,LTD., Hangzhou, Zhejiang (CN)

(21) Appl. No.: 14/892,405

(22) PCT Filed: Apr. 2, 2014
(86) PCT No.: PCT/CN2014/074587

§ 371 Date: Nov. 19, 2015

(30) Foreign Application Priority Data
May 22, 2013 (CN) 201310196644.8

(51) Int. Cl. H04L 12/46; H04L 12/18

(52) U.S. Cl. CPC H04L 12/4633; H04L 12/4641; H04L 12/462; H04L 12/18

(57) ABSTRACT

A first BEB device may receive a first LSP packet transmitted from each second BEB device. According to the received first LSP packet, the first BEB device may calculate multicast tunnel information of the service instance from the first BEB device to the second BEB device in the second B-VLAN. The first BEB device may update multicast tunnel information of the service instance in a data plane according to the multicast tunnel information of the service instance from the first BEB device to the second BEB device.

### BACKGROUND

Shortest Path Bridging (SPB) is an Ethernet protocol defined in IEEE802.1aq, and is extension of a Multiple Spanning Tree Protocol (MSTP). A large flat non-blocking layer 2 network can be constructed through the SPB. The SPB adopts Intermediate-System to Intermediate-System (SPB-ISIS) based on a shortest path bridge to share a link status in the network. Each node in a network calculates a shortest path between the node and other nodes at the same time, so as to avoid instability introduced by a Spanning Tree Protocol (STP) and inefficient usage of a part of links.

In IEEE802.1aq, a SPB mode, i.e., a M-in-M mode (referred to as SPBM hereinafter) is defined. In SPBM, a packet encapsulation format and a Multi-service instance idea in 802.1ah are adopted. Moreover, a forwarding way of a data plane and a control plane are re-defined. Link status information is studied, and is synchronized in the network via SPB-ISIS. Moreover, a forwarding path is calculated via SPB-ISIS.

In a SPBM network, a user network connects with a backbone network via a backbone edge bridge (BEB). In the backbone network, BEBs are connected with each other via a Backbone Core Bridge (BCB). The BEB is for encapsulating a M-in-M packet from the user network and forwarding the encapsulated M-in-M packet to the backbone network. The BEB is further for decapsulating an M-in-M packet from the backbone network and forwarding the decapsulated M-in-M packet to the user network. The BCB is for forwarding the M-in-M packet according to Backbone Media Access Control (B-MAC) and a Backbone Virtual Local Area Network (B-VLAN).

### BRIEF DESCRIPTION OF THE DRAWINGS

FIG. 1 is a schematic diagram illustrating a process of migrating multicast flow from B-VLAN1 to B-VLAN2 in a SPBM network according to an example of the present disclosure;

FIG. 2 is a schematic diagram illustrating a structure of an ISID-ADDR sub TLV field in a LSP packet according to an example of the present disclosure;

FIG. 3 is a schematic diagram illustrating a process of migrating multicast flow according to an example of the present disclosure;

FIG. 4 is a schematic diagram illustrating a structure of a BEB device according to an example of the present disclosure;

FIG. 5 is a schematic diagram illustrating a structure of a BEB device according to an example of the present disclosure;

FIG. 6 is a schematic diagram illustrating a hardware structure of a BEB device according to an example of the present disclosure;

FIG. 7 is a schematic diagram illustrating a structure of a computing device according to an example of the present disclosure;

FIG. 8 is a flowchart illustrating a method for migrating multicast flow according to an example of the present disclosure.

### DETAILED DESCRIPTION

In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

In a SPBM network, a service instance may be a class of services or a class of users, and may have a unique number, i.e., a Backbone Service Instance Identifier (I-SID), and may be carried in a B-VLAN.

Equal Cost Tree (ECT) migration may be a process of migrating a service instance from an old B-VLAN to a new B-VLAN. The ECT migration may end when the new B-VLAN is configured for the service instance for all devices carrying the service instance and the old B-VLAN may not carry the service instance.

FIG. 8 is a flowchart illustrating a method for migrating multicast flow according to an example of the present disclosure. As shown in FIG. 8, the method includes procedures as follows.

At block 801, a first Backbone Edge Bridge (BEB) device carrying a service instance receives a first link state protocol data unit (LSP) packet transmitted from a second BEB device carrying the service instance, wherein the first LSP packet indicates that the service instance is mapped to a first Backbone Virtual Local Area Network (B-VLAN) and a second B-VLAN and that the second BEB device is a multicast source node and a multicast receiving node of the service instance in the first B-VLAN and the second B-VLAN.

At block 802, the first BEB device calculates multicast tunnel information of the service instance from the first BEB device to the second BEB device in the second B-VLAN according to the received first LSP packet.

At block 803, the first BEB device updates multicast tunnel information of the service instance in a data plane according to the multicast tunnel information of the service instance from the first BEB device to the second BEB device.

In an example of the present disclosure, a process of migrating the multicast flow may include the following stages: a migration starting stage, a pre-migration stage, a migration waiting stage, a migration executing stage, a migration completing stage. A process of migrating multicast flow from a first B-VLAN to a second B-VLAN is taken as an example to illustrate each migration stage of migrating multicast flow of a service instance.

Migration Starting Stage:

A management device may trigger starting ECT migration. For example, the management device may transmit a migration command to all BEB devices carrying the service instance. The migration command carries service instance information and information such as the second B-VLAN to which the service instance is migrated. According to the migration command, each BEB device knows that the service instance is to be migrated from the first B-VLAN to the second B-VLAN. And the ECT migration starts. A BEB device carrying the service instance (referred to as the first BEB device hereinafter) is taken as an example to illustrate a process of migrating flow.

After knowing that the service instance is to be migrated from the first B-VLAN to the second B-VLAN, the first BEB device notifies the information of the second B-VLAN to other devices. The first BEB device may be any of the BEB devices carrying the service instance.

The first BEB device notifies the information of the second B-VLAN to other BEB devices in the service instance through a LSP packet. The first device may transmit a first LSP packet. The LSP packet indicates that the service instance is mapped to the first B-VLAN and the second B-VLAN, and indicates that a sender is as a multicast source node and a multicast receiving node in the first B-VLAN and the second B-VLAN. Thus, the first BEB device finishes notification of the second B-VLAN. The first BEB device triggers a node of a shortest path tree to calculate a filtering database (FDB) in the second B-BLAN and to transmit the FDB to a data plane, wherein the first BEB device is as a multicast source node of the shortest path tree.

After receiving the first LSP packet transmitted from the first BEB device, if the node of the shortest path tree that the first BEB device is the multicast source is an intermediate node of the shortest path tree and there is a corresponding multicast receiver in downstream nodes, the node calculates the FDB of the service instance in the second B-VLAN by taking the first BEB device as a multicast source, and transmits the FDB of the service instance to the data plane. Since a FDB calculated by taking the first BEB device as a multicast source has been transmitted, there are a new FDB and an old FDB calculated by taking the first BEB device is as the multicast source.

Pre-Migration Stage:

After the first BEB device transmits the first LSP packet, the migration starting stage ends, and the pre-migration stage starts.

Each BEB device of the service instance may transmit the first LSP packet. The first BEB device may receive the first LSP packet transmitted from another BEB device of the service instance. BEB devices carrying the service instance corresponding to the multicast flow includes the first BEB device and second BEB devices. The second BEB device is in the BEB devices carrying the service instance and is not the first BEB device.

After receiving the first LSP packet transmitted from a second BEB device of the service instance, if the first BEB device is an intermediate node of the short path tree that the second B-VLAN is as the multicast source node and there is a corresponding multicast receiver in downstream nodes of the first BEB device, the first BEB device may calculate the FDB of the service instance by taking the second B-VLAN as the multicast source.

After the first BEB device receives the first LSP device transmitted from the second BEB device, in a control plane of the first BEB device, multicast tunnel information from the first BEB device to the second BEB device in the first B-VLAN device may be calculated. The multicast tunnel information hereinafter may include information about such as a multicast target address, source B-MAC, I-SID, B-VLAN for performing MAC-in-MAC encapsulation. In an example, the multicast tunnel information may further include information about such as an outputting interface of an encapsulated packet.

Since the service instance is previously carried in the first B-VLAN, the current multicast tunnel information from the first BEB device to the second BEB device in the data plane is the multicast tunnel information from the first BEB device to the second BEB device in the first B-VLAN previously calculated in the control plane. After the first BEB device calculates the multicast tunnel information from the first BEB device to the second BEB device in the second B-VLAN, the multicast tunnel information of the service instance in the data plane may not be updated with the multicast tunnel information in the second B-VLAN temporarily. Since processing capabilities and busy conditions of various devices in a network may be different, a certain device may not calculate a FDB in the second B-VLAN and transmit the FDB in the second B-VLAN to the data plane. If the multicast tunnel information from the first BEB device and the second BEB device in the first B-VLAN is updated with the multicast tunnel information from the first BEB device and the second BEB device in the second B-VLAN in the data plane, multicast flow that the first BEB device is as the multicast source may be switched to the second B-VLAN in advance. The multicast flow may be interrupted. In the pre-migration stage, although the multicast tunnel information from the first BEB device to the second BEB device in the second B-VLAN is calculated, the multicast flow of the service instance is transmitted in the first B-VLAN according to the previous multicast tunnel information in the first B-VLAN.

Migration Waiting Stage:

The first BEB device transmits the first LSP packet in the migration stage, and may receive a first LSP packet transmitted from the second BEB device. The first LSP packet transmitted from the second BEB device indicates that a transmitter (the second BEB device, i.e., a BEB device that is in the BEB devices carrying the service instance and is not the first BEB device) is as a multicast source node and a multicast receiving node in the first B-VLAN and the second B-VLAN. The first BEB device calculates the multicast tunnel information from the first BEB device to the second BEB device in the second B-VLAN according to the first LSP packet transmitted from the second BEB device. When the first BEB device receives first LSP packets respectively transmitted from all BEB devices carrying the service instance but not including the first BEB device itself, i.e., all second BEB devices, the pre-migration stage ends, and the migration waiting stage starts.

Since the processing capabilities and the busy conditions may be different from various devices in the network, a device that the processing capability is bad or a busy device may not timely calculate the FDB of the service instance in the second B-VLAN and transmit the calculated FDB to the data plane. After pre-migration stage, in order to avoid interrupting the multicast flow, the first BEB device may not immediately switch the flow of the service instance to the second B-VLAN. The first BEB device may wait for a period of time in the migration waiting stage.

In an example, when receiving first LSP packets respectively transmitted from all second BEB devices, the first BEB device may start a migration waiting timer. When the migration waiting timer expires, the migration waiting stage ends, and the migration executing stage starts. All the second BEB devices may be all other BEB devices carrying the service instance except the first BEB device.

In an example, the first BEB device may configure a timing duration of the migration waiting timer with zero. The migration executing stage may directly start. The timing duration of the migration waiting timer may be calculated as follows:

T=D×P×K, wherein T is the timing duration of the migration waiting timer, D is the maximum number of hops from a root node to a leaf node in a shortest path tree (SPT) that the root node is the first BEB device, P is a period of transmitting a LSP packet in a SPB network, K is a preset adjusting parameter, a value of K may be adjusted according to a practical network quality and a device processing capability. For example, when the value of K is 0, it is indicated that the migration waiting timer is skipped.

Migration Executing Stage:

The first BEB device updates multicast tunnel information of the service instance in a data plane according to the multicast tunnel information of the service instance from the first BEB device to the second BEB device.

In an example, in the migration executing stage, the first BEB device the multicast tunnel information of the service instance in the data plane is updated according to the multicast tunnel information from the first BEB device respectively to all the second BEB devices in the second B-VLAN. The first BEB device may encapsulate the multicast flow of the service instance and forward the multicast flow of the service instance according to the updated multicast tunnel information (the multicast tunnel information in the second B-VLAN). And the multicast flow of the service instance is switched to the second B-VLAN.

After the multicast flow of the service instance is switched to the second B-VLAN, the first BEB device is not as the multicast source of the service instance in the first B-VLAN. The first BEB device may transmit a second LSP packet to notify another device in the network. The second LSP packet indicates that the service instance is mapped to the first B-VLAN and the second B-VLAN and the first BEB device is as the multicast receiving node in the first B-VLAN and is as the multicast source node and the multicast receiving node in the second B-VLAN.

Migration Completing Stage:

In the migration executing stage, the first BEB device transmits the second LSP packet. The first BEB device receives a second LSP packet transmitted from the second BEB device in the migration executing stage of the second BEB device.

When the first BEB device receives second LSP packets respectively transmitted from all second BEB devices, the migration executing stage ends and the migration completing stage starts.

In the migration completing stage, all BEB devices carrying the service instance switches the multicast flow of the service instance to the second B-VLAN. The first BEB device may transmit a third LSP packet. The third LSP packet indicates that the service instance is mapped to the second B-VLAN, and the first BEB device is as the multicast source node and the multicast receiving node of the service node in the second B-VLAN. The third packet carries an association of the service instance and the second B-VLAN, and does not carry an association of the service instance and the first B-VLAN. Since the third LSP packet does not carry an association of the service instance and the first B-VLAN, it is indicated that the association of the service instance and the first B-VLAN has been deleted and the service instance has been migrated from the first B-VLAN to the second B-VLAN.

Since the third LSP packet transmitted from the second BEB device does not carry the association of the service instance and the first B-VLAN, after receiving the third LSP packet, a node of the shortest path tree that the first BEB device is as the multicast source may delete a previous corresponding FDB in the first B-VLAN. The first B-VLAN does not carry the multicast flow of the service instance.

In an example, a LSP packet may include an ISID-ADDR sub-TLV field to carry the association of the service instance (indicated through the I-SID) and the B-VLAN, and an association of a B-MAC and the B-VLAN. When receiving a LSP packet transmitted from another device in the network, calculation related with multicast may be performed according to the ISID-ADDR sub-TLV field in the LSP packet. As shown in FIG. 2, the ISID-ADDR sub-TLV field may include multiple associations of service instances corresponding to I-SIDs and B-VLANs (identified through Base VIDs). An association corresponds to a transmit allow bit (referred as to T Bit hereinafter) and a receive allowed bit (referred as to R Bit hereinafter), wherein the T Bit is an indication that a device transmitting a LSP including a sub-TLV is as a multicast source node of the service instance corresponding to the I-SID with the T Bit set, and R Bit is an indication that a device transmitting a LSP including a sub-TLV is as a multicast receiving node of the service instance corresponding to the I-SID with the R Bit set. A device may be as a multicast source node of a service instance corresponding to an I-SID, may also be as a multicast receiving node of the service instance of the I-SID.

In an example of the present disclosure, the first BEB device indicates whether the first BEB device is as the multicast source node and whether the first BEB device is as the multicast receiving node respectively by setting the T Bit and the R Bit corresponding to the association of the service instance corresponding to the I-SID and the B-VLAN in the ISID-ADDR sub-TLV field.

In the pre-migration stage, before transmitting the first LSP packet, the first BEB device may generate the first LSP packet. The LSP packet carries a first association of the service instance and the first B-VLAN, a second association of the service instance and the second B-VLAN, wherein the first association at least includes an identifier of the first B-VLAN (Base VID 1), the identifier of the service instance (I-SID), a T Bit set, an R Bit set, the second association at least include an identifier of the second B-VLAN (Base VID 3), the identifier of the service instance (I-SID), a T Bit set, an R Bit set.

For example, in the ISID-ADDR sub-TLV field carried in a LSP packet, B-VLANs to which the service instance is mapped include the first B-VLAN and the second B-VLAN, a T Bit and an R Bit corresponding to the first B-VLAN are set, a T Bit and an R Bit corresponding to the second B-VLAN are set. The LSP packet is transmitted as the first LSP packet to indicate that the BEB device transmitting the LSP packet is as the multicast source node and the multicast receiving node of the service instance in the first B-VLAN and the second B-VLAN.

In the migration executing stage, before receiving the second LSP packet, the first BEB device may generate the second LSP packet. The second LSP packet carries a first association of the service instance and the first B-VLAN, a second association of the service instance and the second B-VLAN, wherein the first association at least includes an identifier of the first B-VLAN (Base VID 1), the identifier of the service instance (I-SID), a T Bit cleared, an R Bit set, the second association at least include an identifier of the first B-VLAN (Base VID 3), the identifier of the service instance (I-SID), a T Bit set, an R Bit set.

For example, in the ISID-ADDR sub-TLV field carried in a LSP packet, B-VLANs to which the service instance is mapped include the first B-VLAN and the second B-VLAN, a T Bit corresponding to the first B-VLAN cleared, an R Bit corresponding to the first B-VLAN set. A T Bit and an R Bit corresponding to the second B-VLAN are set. The LSP packet is transmitted as the second LSP packet to indicate that the BEB device transmitting the LSP packet is as the multicast receiving node of the service instance in the first B-VLAN and is as the multicast source node and the multicast receiving node of the service instance in the second B-VLAN.

Before transmitting the third LSP packet, the first BEB device generates the third LSP packet. The third LSP packet carries a second association of the service instance and the second B-VLAN, wherein the second association at least include an identifier of the second B-VLAN (Base VID 3), the identifier of the service instance (I-SID), a T Bit set, an R Bit set.

For example, in the ISID-ADDR sub-TLV field carried in a LSP packet, a B-VLAN to which the service instance is mapped includes the second B-VLAN, a T Bit corresponding to the second B-VLAN set, an R Bit corresponding to the second B-VLAN set. The LSP packet is transmitted as the third LSP packet to indicate that the BEB device transmitting the LSP packet is as the multicast source node and the multicast receiving node of the service instance in the second B-VLAN.

It can be seen from the above five stages of the ECT migration that, in the pre-migration stage, the BEB device has calculated the multicast tunnel information of the service instance in the second B-VLAN. The multicast tunnel information of the service instance in the data plane is updated with the calculated multicast tunnel information of the service instance in the second B-VLAN in the migration executing stage. And the multicast flow is switched to the second B-VLAN. There is a migration waiting stage between the pre-migration stage and the migration executing stage to ensure that another device in the network has enough time to calculate a FDB of the service instance by taking the BEB device as the multicast source in the second B-VLAN and transmit the FDB to the data plane, so as to ensure that the multicast flow of the service instance cannot be interrupted.

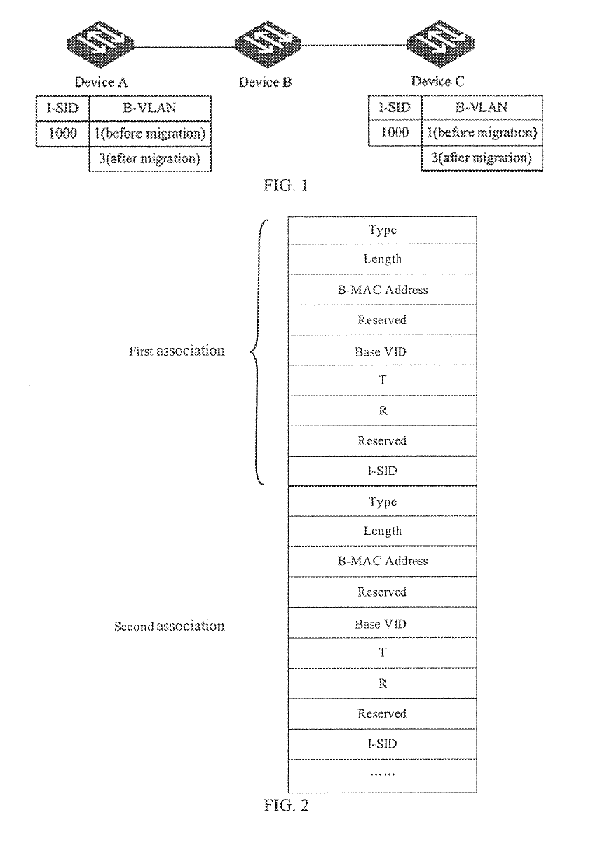

As shown in FIG. 1, it is taken as an example that a service instance I-SID1000 is migrated from a B-VLAN 1 to a B-VLAN 3.

As shown in FIG. 1, in a SPBM network, a device A and a device C are BEB devices. a device B is a BCB device, the device A and the device C are configured to carry the I-SID 1000 in the B-VLAN 1.

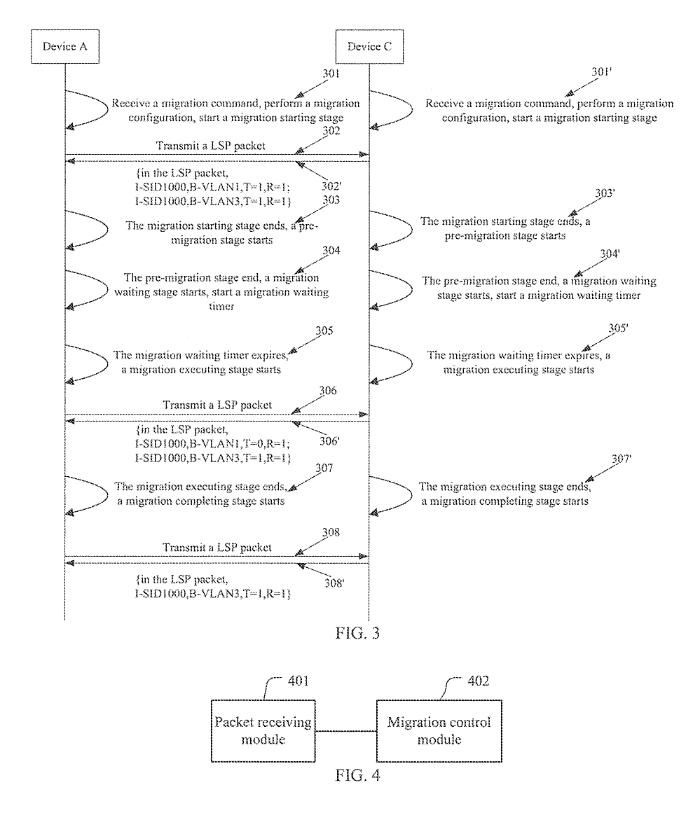

FIG. 3 is a schematic diagram illustrating a process for migrating multicast flow based on FIG. 1 according to an example of the present disclosure. The process includes the following procedures.

Firstly, at block 301 and block 301′, the device A and the device C receives a migration command and determines performing ECT migration, wherein the migration command in this example indicates the I-SID 1000 is migrated from the B-VLAN 1 to the B-VLAN 3. A migration configuration is performed and a migration starting stage starts.

Afterwards, at block 302 and 302′, the device A and device C respectively transmit first LSP packets. In ISID-ADDR sub-TLV fields of the first LSP packets, a T Bit and an R Bit corresponding to a association of the B-VLAN 1 and the I-SID 1000 are set to indicate that the device A and the device C are as multicast source nodes and multicast receiving nodes of the I-SID 1000 in the B-VLAN 1. A T Bit and an R Bit corresponding to an association of the B-VLAN 3 and the I-SID 1000 are set to indicate that the device A and the device C are as multicast source nodes and multicast receiving nodes of the I-SID 1000 in the B-VLAN 3.

After receiving a first LSP packet in the migration starting stage from the device A, the device B may generate a FDB of the I-SID 1000 that the device A is as a multicast source node in the B-VLAN 3. After receiving a first LSP packet in the migration starting stage from the device C, the device B may generate a FDB of the I-SID 1000 that the device C is as a multicast source node in the B-VLAN 3.

At block 303, after the device A transmits the first LSP packet, the migration starting stage ends and a pre-migration stage starts. At block 303′, after the device C transmits the first LSP packet, the migration starting stage ends and a pre-migration stage starts.

Afterwards, after receiving the first LSP packet transmitted from the device C in the migration starting stage, the device A calculates multicast tunnel information of the I-SID 1000 in the B-VLAN 3 according to the first LSP packet, and prohibits updating multicast tunnel information of the I-SID 1000 in the data plane with the calculated multicast tunnel information. After receiving the first LSP packet transmitted from the device A in the migration starting stage, the device C calculates multicast tunnel information of the I-SID 1000 in the B-VLAN 3 according to the first LSP packet, and prohibits updating multicast tunnel information of the I-SID 1000 in the data plane with the calculated multicast tunnel information.

Since there are only two BEB devices, i.e., the device A and the device C in the network, at block 304, after the device A receives the first LSP packet transmitted by the device C, the pre-migration stage ends, and a migration waiting stage starts. At block 304′, after the device C receives the first LSP packet transmitted by the device A, the pre-migration stage ends, and a migration waiting stage starts.

Afterwards, at block 304, the device A starts a migration waiting timer in the migration waiting stage. At block 304′, the device C starts a migration waiting timer in the migration waiting stage.

At block 305, after the migration waiting timer of the device A expires, the migration waiting stage ends, and a migration executing stage starts. At block 305′, after the migration waiting timer of the device C expires, the migration waiting stage ends, and a migration executing stage starts.

Afterwards, at block 306, the device A transmits a second LSP packet in the migration executing stage, and updates the multicast tunnel information of the I-SID 1000 in the data plane with the multicast tunnel information of I-SID 1000 in the B-VLAN 3 calculated previously by the device A, so as to multicast flow of the I-SID 1000 can be switched to the B-VLAN 3. At block 306′, the device C transmits a second LSP packet in the migration executing stage, and updates the multicast tunnel information of the I-SID 1000 in the data plane with the multicast tunnel information of I-SID 1000 in the B-VLAN 3 calculated previously by the device C, so as to multicast flow of the I-SID 1000 can be switched to the B-VLAN 3.

In an ISID-ADDR sub-TLV field of the second LSP packet transmitted from the device A in the migration executing stage, the T Bit corresponding to the association of B-VLAN 1 and I-SID 1000 is cleared, and R Bit corresponding to the association of B-VLAN 1 and I-SID 1000 is set to indicate that the device A is as a multicast receiving node of the I-SID 1000 in the B-VLAN 1, and is not as the multicast source node of the I-SID 1000 in the B-VLAN 1. The T Bit and the R Bit corresponding to the association of B-VLAN 3 and I-SID 1000 is set to indicate that the device A is as the multicast receiving node and the multicast source node of the I-SID 1000 in the B-VLAN 3.

In an ISID-ADDR sub-TLV field in the second LSP packet transmitted from the device C in the migration executing stage, the T Bit corresponding to the association of B-VLAN 1 and I-SID 1000 is cleared, and R Bit corresponding to the association of B-VLAN 1 and I-SID 1000 is set to indicate that the device C is as a multicast receiving node of the I-SID 1000 in the B-VLAN 1, and is not as the multicast source node of the I-SID 1000 in the B-VLAN 1. The T Bit and the R Bit corresponding to the association of B-VLAN 3 and I-SID 1000 is set to indicate that the device C is as the multicast receiving node and the multicast source node of the I-SID 1000 in the B-VLAN 3.

At block 307, when the device A receives the second LSP packet transmitted from the device C in the migration executing stage, the migration executing stage ends, and the migration ending stage starts. At block 307′, when the device C receives the second LSP packet transmitted from the device A in the migration executing stage, the migration executing stage ends, and the migration ending stage starts.

At last, at block 308, the device A transmits a third LSP packet, and deletes the association of the I-SID 1000 and the B-VLAN 1, and the ECT migration ends. At block 308′, the device C transmits a third LSP packet, and deletes the association of the I-SID 1000 and the B-VLAN 1, and the ECT migration ends.

After the ECT migration ends, the LSP packet transmitted from the device A may not carry the association of the I-SID 1000 and the B-VLAN 1. After the ECT migration ends, the LSP packet transmitted from the device C may not carry the association of the I-SID 1000 and the B-VLAN 1. After receiving the LSP packets that are respectively transmitted from the device A and the device C, and do not carry the association of the I-SID 1000 and the B-VLAN 1, the device B may delete the FDB of the I-SID 1000 in the B-VLAN 1.

A BEB device is provided according to an example of the present disclosure. In the example, a SPB network to which the BEB device belongs may apply an M-in-M mode.

FIG. 4 is a schematic diagram illustrating a structure of a first BEB device according to an example of the present disclosure. As shown in FIG. 4, the first BEB device includes a packet receiving module 401, and a migration control module 402.

The packet receiving module 401 is to receive a first link state protocol data unit (LSP) packet transmitted from each second BEB device, wherein the first LSP packet indicates that the service instance is mapped to a first Backbone Virtual Local Area Network (B-VLAN) and a second B-VLAN and that the second BEB device is as a multicast source node and a multicast receiving node of the service instance in the first B-VLAN and the second B-VLAN.

The migration control module 402 is to calculate multicast tunnel information of the service instance from the first BEB device to the second BEB device in the second B-VLAN according to the first LSP packet received by the packet receiving module, update multicast tunnel information of the service instance in a data plane according to the calculated multicast tunnel information of the service instance from the first BEB device to the second BEB device.

In an example, the migration control module 402 is to after respectively calculating the multicast tunnel information of the service instance from the first BEB device to all the second BEB devices in the second B-VLAN, update multicast tunnel information of the service instance in a data plane according to the calculated multicast tunnel information of the service instance from the first BEB device respectively to all the second BEB devices in the second B-VLAN.

FIG. 5 is a schematic diagram illustrating a structure of a first BEB device according to an example. As shown in FIG. 5, the first BEB device includes a packet transmitting module 501, a packet receiving module 502, and a migration control module 503.

The packet transmitting module 501 is to transmit a first LSP packet when the service instance is to be migrated from a first B-VLAN to a second B-VLAN, wherein the first LSP packet indicates that the service instance is mapped to the first B-VLAN and the second B-VLAN and that the first BEB device is a multicast source node and a multicast receiving node in the first B-VLAN and the second B-VLAN.

The packet receiving module 502 is to receive a first LSP packet transmitted from each second BEB device.

A function of the packet receiving module 502 is similar with that of a packet receiving module 401 in FIG. 4.

The migration control module 503 is to calculate multicast tunnel information of the service instance from the first BEB device to the second BEB device in the second B-VLAN according to the first LSP packet received by the packet receiving module, update multicast tunnel information of the service instance in a data plane according to the calculated multicast tunnel information of the service instance from the first BEB device to the second BEB device.

In an example, the migration control module 503 is to after the packet receiving module 502 receives the first LSP packets respectively from all the second BEB devices, update multicast tunnel information of the service instance in a data plane according to the calculated multicast tunnel information of the service instance from the first BEB device respectively to all the second BEB devices in the second B-VLAN.

A function of the migration control module 503 is similar with that of a migration control module 402 in FIG. 4.

In the first BEB device, the migration control module 503 is to start a migration waiting timer after receiving the first LSP packets respectively from all the second BEB devices, start a migration waiting timer, update the multicast tunnel information of the service instance in the data plane according to the multicast tunnel information of the service instance from the first BEB device respectively to all the second BEB devices in the second B-VLAN after the migration waiting timer expires so as to migrate the multicast flow of the service instance that the first BEB device is the multicast source node to the second B-VLAN.

In the first BEB device, the packet transmitting module 501 is further to transmit a second LSP packet after the first BEB device migrates the multicast flow of the service instance that the first BEB device is the multicast source node to the second B-VLAN, wherein the second LSP packet transmitted by the first BEB device indicates that the service instance is mapped to the first B-VLAN and that the first BEB device is as a multicast receiving node in the first B-VLAN and is as a multicast source node and a multicast receiving node in the second B-VLAN

The packet receiving module 502 is further to receive a second LSP packet transmitted from the second BEB device, wherein the second LSP packet indicates that the service instance is mapped to the first B-VLAN and the second B-VLAN and that the second BEB device is as the multicast receiving node in the first B-VLAN and is as the multicast source node and a multicast receiving node in the second B-VLAN.

The packet transmitting module 501 is further to transmit a third LSP packet after receiving second LSP packets respectively from all the second BEB devices, wherein the third LSP packet indicates that the service instance is mapped to the second B-VLAN and that the first BEB device is as the multicast source node and the multicast receiving node in the second B-VLAN.

In the first BEB device, the packet transmitting module 501 is further to before transmitting the first LSP packet, generate the first LSP packet, wherein the first LSP packet carries a first association of the service instance and the first B-VLAN and a second association of the service instance and the second B-VLAN, wherein the first association at least includes an identifier of the first B-VLAN (Base VID 1), the identifier of the service instance (I-SID), a T Bit set, an R Bit set, the second association at least include an identifier of the second B-VLAN (Base VID 3), the identifier of the service instance (I-SID), a T Bit set, an R Bit set.

For example, in the ISID-ADDR sub-TLV field carried in a LSP packet, B-VLANs to which the service instance is mapped include the first B-VLAN and the second B-VLAN. A T Bit and an R Bit corresponding to the first B-VLAN are set, A T Bit and an R Bit corresponding to the second B-VLAN are set. The LSP packet is transmitted as the first LSP packet.

The packet transmitting module 501 is further to before receiving the second LSP packet, generate the second LSP packet. The second LSP packet carries a first association of the service instance and the first B-VLAN, and a second association of the service instance and the second B-VLAN, wherein the first association at least includes an identifier of the first B-VLAN (Base VID 1), the identifier of the service instance (I-SID), a T Bit cleared, an R Bit set, the second association at least include an identifier of the first B-VLAN (Base VID 3), the identifier of the service instance (I-SID), a T Bit set, an R Bit set.

For example, in the ISID-ADDR sub-TLV field carried in a LSP packet, B-VLANs to which the service instance is mapped include the first B-VLAN and the second B-VLAN, a T Bit corresponding to the first B-VLAN cleared, an R Bit corresponding to the first B-VLAN set. A T Bit and an R Bit corresponding to the second B-VLAN are set. The LSP packet is transmitted as the second LSP packet.

The packet transmitting module 501 is further to before transmitting the third LSP packet, generate the third LSP packet. The third LSP packet carries a second association of the service instance and the second B-VLAN, wherein the second association at least include an identifier of the second B-VLAN (Base VID 3), the identifier of the service instance (I-SID), a T Bit set, an R Bit set.

For example, in the ISID-ADDR sub-TLV field carried in a LSP packet, a B-VLAN to which the service instance is mapped includes the second B-VLAN, a T Bit corresponding to the second B-VLAN set, an R Bit corresponding to the second B-VLAN set.

In the first BEB device, the migration control module is to calculate the timing duration of the migration waiting timer as follows:

T=D×P×K, wherein T is the timing duration of the migration waiting timer, D is the maximum number of hops from a root node to a leaf node in a shortest path tree (SPT) that the root node is the first BEB device, P is a period of transmitting a LSP packet in a SPB network, K is a preset adjusting parameter.

A method and a device for migrating multicast flow in a SPB network applying a M-in-M mode may be implemented based on a hardware structure of a BEB device applying the method and the apparatus.

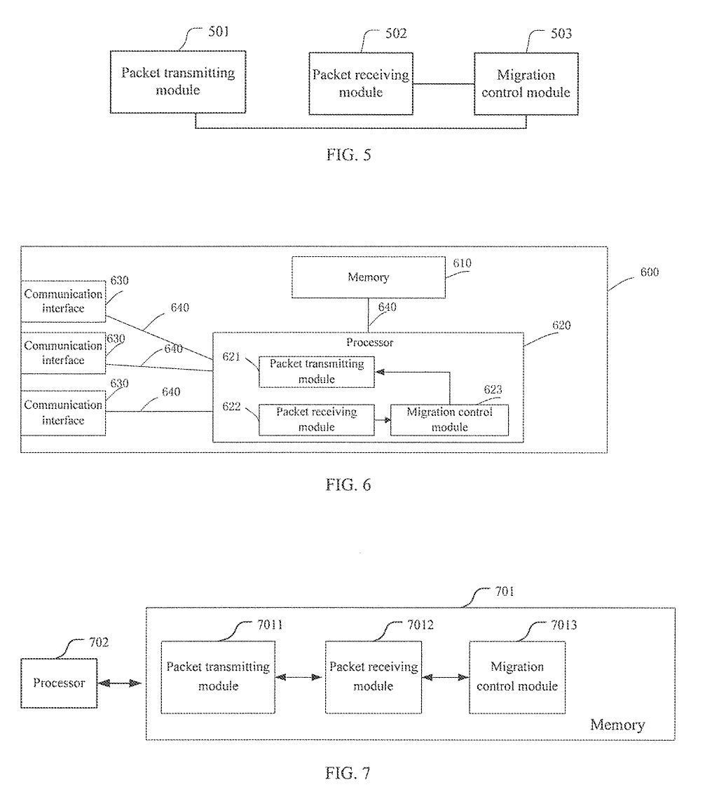

FIG. 6 is a schematic diagram illustrating a hardware structure of a first BEB device according to an example of the present disclosure. As shown in FIG. 6, a hardware structure of the first BEB device 600 applying a method and a device for migrating multicast flow in a SPB network applying a M-in-M mode includes a memory 610, a processor 620, a communication interface 630 and an interconnection body 640 for coupling the memory 610, the processor 620 and the communication interface 630.

The memory 610 is to store multicast tunnel information in a B-VLAN calculated during a process of migrating multicast flow of a service instance configured by the first BEB device.

The processor 602 may be a CPU, and may include a packet receiving module 621, a packet transmitting module 622, and a migration control module 623.

The packet receiving module 621 is to receive a first LSP packet and a second LSP packet transmitted by each second BEB device via the communication interface, wherein BEB devices carrying the service instance corresponding to the multicast flow includes the first BEB device and second BEB devices. The second BEB device is in the BEB devices carrying the service instance and is not the first BEB device.

The packet transmitting module 622 is to transmit a first LSP packet and a second LSP packet via the communication interface.

The migration control module 623 is to perform the following processes according to the first LSP packet and the second LSP packet received via the packet receiving module: such as calculating multicast tunnel information, starting a migration waiting timer, determining expiration of the migration waiting timer, switching the multicast flow.

The communication interface 630 is to transmit the first LSP packet and the second LSP packet from each second BEB device of the service instance to the packet receiving module, and transmit the first LSP packet and the second LSP packet from the packet transmitting module.

Based on functions in the hardware structure, it is clear how steps of the method and modules of a device for migrating multicast flow in the SPB network applying the M-in-M mode are implemented in the hardware structure.

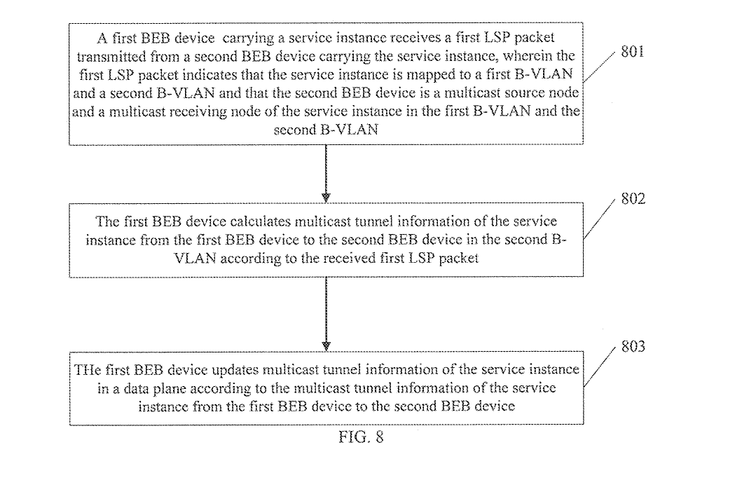

FIG. 7 is a schematic diagram illustrating a structure of a computing device according to an example of the present disclosure. As shown in FIG. 7, the computing device includes a processor 702 for executing instructions stored in a memory 701. The instructions include a packet transmitting instruction 7011, a packet receiving instruction 7012, and a migration control instruction 7013.

The packet transmitting instruction 7011 is to transmit a first LSP packet when the service instance is to be migrated from a first B-VLAN to a second B-VLAN, wherein the first LSP packet indicates that the service instance is mapped to the first B-VLAN and the second B-VLAN and that the first BEB device is a multicast source node and a multicast receiving node in the first B-VLAN and the second B-VLAN.

The packet receiving instruction 7012 is to receive a first LSP packet transmitted from each second BEB device.

The migration control instruction 7013 is to calculate multicast tunnel information of the service instance from the first BEB device to the second BEB device in the second B-VLAN according to the first LSP packet received by the packet receiving module, update multicast tunnel information of the service instance in a data plane according to the calculated multicast tunnel information of the service instance from the first BEB device to the second BEB device.

In an example, the migration control instruction 7013 is to after the packet receiving instruction 7012 receives the first LSP packets respectively from all the second BEB devices, update multicast tunnel information of the service instance in a data plane according to the calculated multicast tunnel information of the service instance from the first BEB device respectively to all the second BEB devices in the second B-VLAN.

In the first BEB device, the migration control instruction 7013 is to start a migration waiting timer after receiving the first LSP packets respectively from all the second BEB devices, start a migration waiting timer, update the multicast tunnel information of the service instance in the data plane according to the multicast tunnel information of the service instance from the first BEB device respectively to all the second BEB devices in the second B-VLAN after the migration waiting timer expires so as to migrate the multicast flow of the service instance that the first BEB device is the multicast source node to the second B-VLAN.

In the first BEB device, the packet transmitting instruction 7011 is further to transmit a second LSP packet after the first BEB device migrates the multicast flow of the service instance that the first BEB device is the multicast source node to the second B-VLAN, wherein the second LSP packet transmitted by the first BEB device indicates that the service instance is mapped to the first B-VLAN and that the first BEB device is as a multicast receiving node in the first B-VLAN and is as a multicast source node and a multicast receiving node in the second B-VLAN

The packet receiving instruction 7012 is further to receive a second LSP packet transmitted from the second BEB device, wherein the second LSP packet indicates that the service instance is mapped to the first B-VLAN and the second B-VLAN and that the second BEB device is as the multicast receiving node in the first B-VLAN and is as the multicast source node and a multicast receiving node in the second B-VLAN.

The packet transmitting instruction 7011 is further to transmit a third LSP packet after receiving second LSP packets respectively from all the second BEB devices, wherein the third LSP packet indicates that the service instance is mapped to the second B-VLAN and that the first BEB device is as the multicast source node and the multicast receiving node in the second B-VLAN.

In the first BEB device, the packet transmitting instruction 7011 is further to before transmitting the first LSP packet, generate the first LSP packet, wherein the first LSP packet carries a first association of the service instance and the first B-VLAN and a second association of the service instance and the second B-VLAN, wherein the first association at least includes an identifier of the first B-VLAN (Base VID 1), the identifier of the service instance (I-SID), a T Bit set, an R Bit set, the second association at least include an identifier of the second B-VLAN (Base VID 3), the identifier of the service instance (I-SID), a T Bit set, an R Bit set.

For example, in the ISID-ADDR sub-TLV field carried in a LSP packet, B-VLANs to which the service instance is mapped include the first B-VLAN and the second B-VLAN. A T Bit and an R Bit corresponding to the first B-VLAN are set. A T Bit and an R Bit corresponding to the second B-VLAN are set. The LSP packet is transmitted as the first LSP packet.

The packet transmitting instruction 7011 is further to before receiving the second LSP packet, generate the second LSP packet. The second LSP packet carries a first association of the service instance and the first B-VLAN, and a second association of the service instance and the second B-VLAN, wherein the first association at least includes an identifier of the first B-VLAN (Base VID 1), the identifier of the service instance (I-SID), a T Bit cleared, an R Bit set, the second association at least include an identifier of the first B-VLAN (Base VID 3), the identifier of the service instance (I-SID), a T Bit set, an R Bit set.

For example, in the ISID-ADDR sub-TLV field carried in a LSP packet, B-VLANs to which the service instance is mapped include the first B-VLAN and the second B-VLAN, a T Bit corresponding to the first B-VLAN cleared, an R Bit corresponding to the first B-VLAN set. A T Bit and an R Bit corresponding to the second B-VLAN are set. The LSP packet is transmitted as the second LSP packet.

The packet transmitting instruction 7011 is further to before transmitting the third LSP packet, generate the third LSP packet. The third LSP packet carries a second association of the service instance and the second B-VLAN, wherein the second association at least include an identifier of the second B-VLAN (Base VID 3), the identifier of the service instance (I-SID), a T Bit set, an R Bit set.

For example, in the ISID-ADDR sub-TLV field carried in a LSP packet, a B-VLAN to which the service instance is mapped includes the second B-VLAN, a T Bit corresponding to the second B-VLAN set, an R Bit corresponding to the second B-VLAN set.

In the first BEB device, the migration control instruction is to calculate the timing duration of the migration waiting timer as follows:

T=D×P×K, wherein T is the timing duration of the migration waiting timer, D is the maximum number of hops from a root node to a leaf node in a shortest path tree (SPT) that the root node is the first BEB device, P is a period of transmitting a LSP packet in a SPB network, K is a preset adjusting parameter.

What is claimed is:

1. A method for migrating multicast flow, comprising:
receiving, by a first Backbone Edge Bridge (BEB) device carrying a service instance, a first link state protocol data unit (LSP) packet transmitted from a second BEB device carrying the service instance, wherein the first LSP packet indicates that the service instance is mapped to a first Backbone Virtual Local Area Network (B-VLAN) and a second B-VLAN and that the second BEB device is a multicast source node and a multicast receiving node of the service instance in the first B-VLAN and the second B-VLAN;
calculating, by the first BEB device, multicast tunnel information of the service instance from the first BEB device to the second BEB device in the second B-VLAN according to the received first LSP packet;
updating, by the first BEB device, multicast tunnel information of the service instance in a data plane according to the multicast tunnel information of the service instance from the first BEB device to the second BEB device.

2. The method of claim 1, wherein updating the multicast tunnel information of the service instance in a data plane according to the multicast tunnel information of the service instance from the first BEB device to the second BEB device comprises:
after calculating the multicast tunnel information of the service instance from the first BEB device to all the other BEB devices carrying the service instance in the second B-VLAN, updating, by the first BEB device, multicast tunnel information of the service instance in a data plane according to the multicast tunnel information of the service instance calculated in the second B-VLAN.

3. The method of claim 1, further comprising:
transmitting, by the first LSP device, another first LSP packet, wherein the another first LSP packet indicates that the service instance is mapped to the first B-VLAN and the second B-VLAN and that the first BEB device is a multicast source node and a multicast receiving node in the first B-VLAN and the second B-VLAN.

4. The method of claim 1, wherein updating the multicast tunnel information of the service instance in the data plane according to the multicast tunnel information of the service instance calculated in the second B-VLAN comprises:
starting a migration waiting timer;
updating the multicast tunnel information of the service instance in the data plane according to the multicast tunnel information of the service instance from the first BEB device respectively to all the other BEB devices in the second B-VLAN after the migration waiting timer expires.

5. The method of claim 1, after updating the multicast tunnel information of the service instance in the data plane, further comprising:
receiving, by the first BEB device, a second LSP packet transmitted from the second BEB device, wherein the second LSP packet indicates that the service instance is mapped to the first B-VLAN and the second B-VLAN and that the second BEB device is as a multicast receiving node in the first B-VLAN and is as a multicast source node and a multicast receiving node in the second B-VLAN;
transmitting, by the first BEB device, a third LSP packet after receiving the second LSP packets respectively from all the other BEB devices carrying the service instance, wherein the third LSP packet indicates that the service instance is mapped to the second B-VLAN and that the first BEB device is as the multicast source node and the multicast receiving node in the second B-VLAN.

6. The method of claim 5 further comprising:
transmitting, by the first BEB device, another second LSP packet, wherein the another LSP packet indicates that the service instance is mapped to the first B-VLAN and the second B-VLAN and that the first BEB device is as the multicast receiving node in the first B-VLAN and is as the multicast source node and the multicast receiving node in the second B-VLAN.

7. The method of claim 3 further comprising:
generating the another first LSP packet, wherein the another first LSP packet carries a first association of the service instance and the first B-VLAN and a second association of the service instance and the second B-VLAN,
wherein a transmit allow bit (T Bit) and a receive allow bit (R Bit) in the first association are set, a T Bit and an R Bit in the second B-VLAN are set.

8. A first Backbone Edge Bridge (BEB) device for carrying a service instance, comprising:
a packet receiving module, to receive a first link state protocol data unit (LSP) packet transmitted from a second BEB device carrying the service instance, wherein the first LSP packet indicates that the service instance is mapped to a first Backbone Virtual Local Area Network (B-VLAN) and a second B-VLAN and that the second BEB device is a multicast source node and a multicast receiving node of the service instance in the first B-VLAN and the second B-VLAN;
a migration control module, to calculate multicast tunnel information of the service instance from the first BEB device to the second BEB device in the second B-VLAN according to the first LSP packet received by the packet receiving module, update multicast tunnel information of the service instance in a data plane according to the calculated multicast tunnel information of the service instance from the first BEB device to the second BEB device.

9. The BEB device of claim 8, wherein migration control module is to after calculating the multicast tunnel information of the service instance from the first BEB device to all the other BEB devices carrying the service instance in the second B-VLAN, update multicast tunnel information of the service instance in a data plane according to the multicast tunnel information of the service instance calculated in the second B-VLAN.

10. The BEB device of claim 8, further comprising:
a packet transmitting module, to transmit another first LSP packet, wherein the another first LSP packet indicates that the service instance is mapped to the first B-VLAN and the second B-VLAN and that the first BEB device is a multicast source node and a multicast receiving node in the first B-VLAN and the second B-VLAN.

11. The BEB device of claim 8, wherein
the migration control module is to start a migration waiting timer, update the multicast tunnel information of the service instance in the data plane according to the multicast tunnel information of the service instance from the first BEB device respectively to all the other BEB devices in the second B-VLAN after the migration waiting timer expires.

12. The BEB device of claim 8, wherein
the packet receiving module is further to receive a second LSP packet transmitted from the second BEB device, wherein the second LSP packet indicates that the service instance is mapped to the first B-VLAN and the second B-VLAN and that the second BEB device is as a multicast receiving node in the first B-VLAN and is as a multicast source node and a multicast receiving node in the second B-VLAN;
the packet transmitting module is further to transmit a third LSP packet after receiving second LSP packets respectively from all the other BEB devices carrying the service instance, wherein the third LSP packet indicates that the service instance is mapped to the second B-VLAN and that the first BEB device is as the multicast source node and the multicast receiving node in the second B-VLAN.

13. The BEB device of claim 12, wherein
the packet transmitting module is further to transmit another second LSP packet, wherein the another LSP packet indicates that the service instance is mapped to the first B-VLAN and the second B-VLAN and that the first BEB device is as the multicast receiving node in the first B-VLAN and is as the multicast source node and the multicast receiving node in the second B-VLAN.

14. The BEB device of claim 10, wherein
the packet transmitting module is further to generate the another first LSP packet, wherein the another first LSP packet carries a first association of the service instance and the first B-VLAN and a second association of the service instance and the second B-VLAN, wherein a transmit allow bit (T Bit) and a receive allow bit (R Bit) in the first association are set, a T Bit and an R Bit in the second B-VLAN are set.
